(19) United States
(12) Patent Application Publication
(10) Pub. No.: US 2017/0219878 A1
(43) Pub. Date: Aug. 3, 2017

(54) METHOD FOR FABRICATING LIQUID CRYSTAL DISPLAY PANEL AND POLARIZER

(71) Applicant: SHENZHEN CHINA STAR OPTOELECTRONICS TECHNOLOGY CO., LTD., Guangdong (CN)

(72) Inventor: Guohe Liu, Guangdong (CN)

(73) Assignee: SHENZHEN CHINA STAR OPTOELECTRONICS TECHNOLOGY CO., LTD., Guangdong (CN)

(21) Appl. No.: 14/778,748

(22) PCT Filed: Aug. 7, 2015
(86) PCT No.: PCT/CN2015/086379

§ 371 Date: Sep. 21, 2015

(30) Foreign Application Priority Data
Jul. 24, 2015 (CN) 201510442819.8

(51) Int. Cl. G02F 1/1335; G02B 5/30

(52) U.S. Cl. CPC G02F 1/133528; G02F 1/133514; G02B 5/3025; G02F 2202/04; G02F 2202/36

(57) ABSTRACT

The present invention proposes a liquid crystal display (LCD) panel and a method ofr forming a polarizer. The LCD panel includes a first substrate, a second substrate, a liquid crystal layer placed between the first substrate and the second substrate, and a polarizer arranged on an outside area of the first substrate or an outside area of the second substrate. The polarizer includes a polarizing layer, a quantum rod mixed in raw materials for the polarizing layer for forming mixed materials where the quantum rod is used for increasing transmittance of the polarizer.

### BACKGROUND OF THE INVENTION

1. Field of the Invention

The present invention relates to the field of liquid crystal displays (LCDs), and more particularly, to a method for fabricating an LCD panel and a polarizer.

2. Description of the Prior Art

A polarizer is an important component in an LCD panel. The polarizer is mainly used for encouraging a light beam vibrating along a certain regular direction to pass and blocking off light beams vibrating along other directions so as to control the polarizing direction of the light beams. There are two types of polarizers—dye and loding. Compared with a dye polarizer, a loding polarizer has advantages of high transmittance and high polarization. But, the structure of iodine tends to be destroyed in a high-temperature and high-moisture environment, resulting in the loding polarizer has a disadvantage of poorer endurance or ruggedness. Compared with a loding polarizer, a dye polarizer has advantages of high heat stability and high moisture-proof and a disadvantage of poor transmittance. The highest transmittance of a iodine polarizer is merely about 42%.

Therefore, it is necessary to propose a method for fabricating an LCD panel and a polarizer for solving the technical problem occurring in the conventional technology.

### SUMMARY OF THE INVENTION

An object of the present invention is to propose a method for fabricating an LCD panel and a polarizer for solving the technical problem that the transmittance of the conventional polarizer is poorer.

According to the present invention, a method for fabricating a polarizer comprises: mixing a quantum rod with a solution of azo dyes according to a predetermined proportion for forming a mixed solution, the quantum rod comprising a red quantum rod and a green quantum rod; soaking a polarizing layer which has undergone surface processing in the mixed solution for dyeing and stretching the polarizing layer with a wet-etching extension technique, and the quantum rod and the azo dyes being stretched in the same process; diverting a long axis of molecules of the azo dyes and a long axis of the quantum rod to a direction which a stretching force is applied to. The polarizer comprises the polarizing layer, and both of an azo-dye molecule and the quantum rod comprising the long axis.

In another aspect of the present invention, the quantum rod further comprises a blue quantum rod. Molecules of the azo dyes absorb light beam perpendicular to a first direction when a blue backlight source or a white backlight source shines so as to convert the backlight source as an non-polarized light into a polarized light, and the first direction is parallel to a direction of the long axis of molecules of the azo dyes. The quantum rod converts a partial light beam perpendicular to the first direction into a light beam parallel with the first direction so as to increase transmittance of the polarizer, and the first direction and the long axis of the quantum rod are in parallel.

In another aspect of the present invention, molecules of the azo dyes absorbs the light beam perpendicular to a first direction when a blue backlight source shines so as to convert the backlight source as an non-polarized light into a polarized light, and the first direction is parallel to a direction of the long axis of molecules of the azo dyes. The quantum rod converts a partial light beam perpendicular to the first direction into a light beam parallel with the first direction so as to increase transmittance of the polarizer, and the first direction and the long axis of the quantum rod are in parallel.

In still another aspect of the present invention, the red quantum rod and the green quantum rod emit a red light beam with polarization and a green light beam with polarization, respectively, after being excited by the blue backlight source. The red light beam, the green light beam, and the blue backlight are mixed as a light source for colorful display of a liquid crystal display (LCD) panel.

According to the present invention, a liquid crystal display (LCD) panel comprises: a first substrate; a second substrate, arranged opposite to the first substrate; a liquid crystal layer, placed between the first substrate and the second substrate; and a polarizer, arranged on an outside area of the first substrate or an outside area of the second substrate, the polarizer comprising a polarizing layer, a quantum rod mixed in raw materials for the polarizing layer for forming mixed materials where the quantum rod is used for increasing transmittance of the polarizer.

In another aspect of the present invention, the mixed materials for the polarizing layer comprises azo dyes.

In another aspect of the present invention, the polarizer is fabricated after the mixed materials for the polarizing layer are dyed and stretched, and the quantum rod and the azo dyes are stretched in the same process.

In still another aspect of the present invention, a backlight source cooperating with the polarizer is blue or white backlight source upon a condition that the red quantum rod, the green quantum rod, and the blue quantum rod are mixed as part of the raw materials for the polarizer.

In yet another aspect of the present invention, a backlight source cooperating with the polarizer is blue or white backlight source upon a condition that the red quantum rod and the green quantum rod are mixed as part of the raw materials for the polarizer.

According to the present invention, a method for fabricating a polarizer comprises: mixing a quantum rod with a solution of azo dyes according to a predetermined proportion for forming a mixed solution; soaking a polarizing layer which has undergone surface processing in the mixed solution for dyeing and stretching the polarizing layer with a wet-etching extension technique; diverting a long axis of molecules of the azo dyes and a long axis of the quantum rod to a direction which a stretching force is applied to. The polarizer comprises the polarizing layer, and both of an azo-dye molecule and the quantum rod comprise the long axis.

In one aspect of the present invention, the quantum rod comprises a red quantum rod, a green quantum rod, and a blue quantum rod. Molecules of the azo dyes absorb light beam perpendicular to a first direction when a blue backlight source or a white backlight source shines so as to convert the backlight source as an non-polarized light into a polarized light, and the first direction is parallel to a direction of the long axis of molecules of the azo dyes. The quantum rod converts a partial light beam perpendicular to the first direction into a light beam parallel with the first direction so as to increase transmittance of the polarizer, and the first direction and the long axis of the quantum rod are in parallel.

In another aspect of the present invention, the quantum rod comprises a red quantum rod and a green quantum rod. Molecules of the azo dyes absorb light beam perpendicular to a first direction when a blue backlight source shines so as to convert the backlight source as an non-polarized light into a polarized light, and the first direction is parallel to a direction of the long axis of molecules of the azo dyes. The quantum rod converts a partial light beam perpendicular to the first direction into a light beam parallel with the first direction so as to increase transmittance of the polarizer, and the first direction and the long axis of the quantum rod are in parallel.

In another aspect of the present invention, the red quantum rod and the green quantum rod emit a red light beam with polarization and a green light beam with polarization, respectively, after being excited by the blue backlight source, and the red light beam, the green light beam, and the blue backlight are mixed as a light source for colorful display of a liquid crystal display (LCD) panel.

In still another aspect of the present invention, the quantum rod and the azo dyes are stretched in the same process.

In yet another aspect of the present invention, the first substrate is a color filter substrate and the second substrate is an array substrate.

In contrast to prior art, the material for the polarizer of the LCD panel proposed by the present invention is mixed with quantum rods. Owing to anisotropy of the quantum rods, the transmittance of the polarizer increases, and chroma and color gamut of the LCD panel improve as well.

### BRIEF DESCRIPTION OF THE DRAWINGS

FIG. 1 is a schematic diagram of a polarizer according to preferred embodiment of the present invention.

FIG. 2 shows azo dyes and quantum rods during stretching.

FIG. 3 shows a diagram of a polarizer shined by a backlight source according to the present invention.

FIG. 4 is a schematic diagram of a backlight source shining on the polarizer according to a first embodiment of the present invention.

FIG. 5 is a schematic diagram of a backlight source shining on a polarizer according to a second embodiment of the present invention.

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

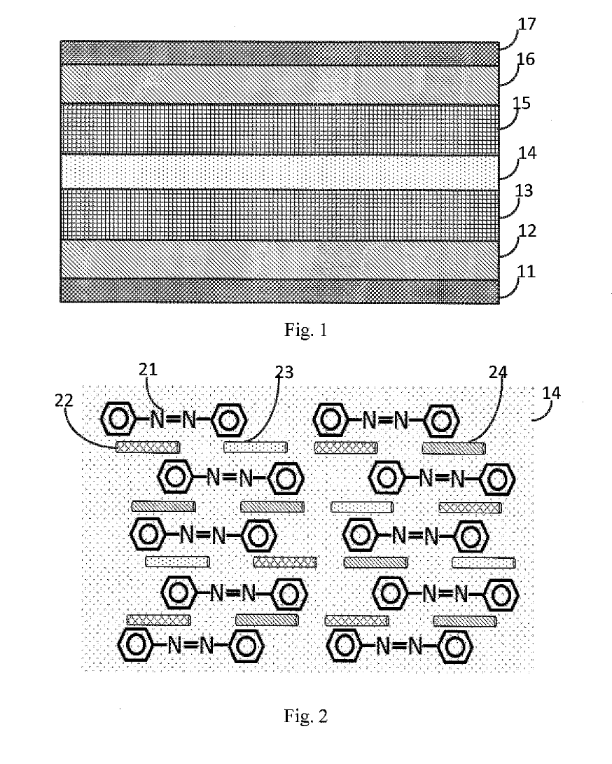

Please refer to FIG. 1. FIG. 1 is a schematic diagram of a polarizer according to preferred embodiment of the present invention.

An LCD panel used in the present invention comprises a first substrate, a second substrate, a liquid crystal layer, and a polarizer. The second substrate is arranged opposite to the first substrate. The liquid crystal layer is placed between the first substrate and the second substrate. The polarizer is arranged on an outside area of the first substrate or an outside area of the second substrate (far away from the liquid crystal layer).

The first substrate may be a color filter substrate. The second substrate may be an array substrate. The polarizer comprises a protective film 11, a coating layer 12, a first supporting layer 13, a polarizing layer 14, a second supporting layer 15, a surface processing layer 16, and a protective film 17. A quantum rod is mixed in raw materials for the polarizing layer 14. The raw materials for the polarizing layer 14 may be polyvinyl alcohol (PVA). The quantum rod and PVA are mixed as a mixed materials. The quantum rod is used for increasing the transmittance of the polarizer.

The quantum rod is fabricated from nanometer material made from semiconducting atoms. Different from quasi-zero-dimensional material, the quantum rod is far larger in one direction than other two directions. The quantum rod is fabricated from one-dimensional material. Structural anisotropy of the quantum rod results in optical anisotropy of the material for the quantum rod. Optical anisotropy means that the absorption of light and strength of emission by the long axis of the quantum rod is higher than that of the direction perpendicular to the long axis of the quantum rod. Once the quantum rods are added to the raw materials for the polarizer, the transmittance of the LCD panel will increase owing to optical anisotropy of the quantum rod. Besides, energy and costs will be reduced.

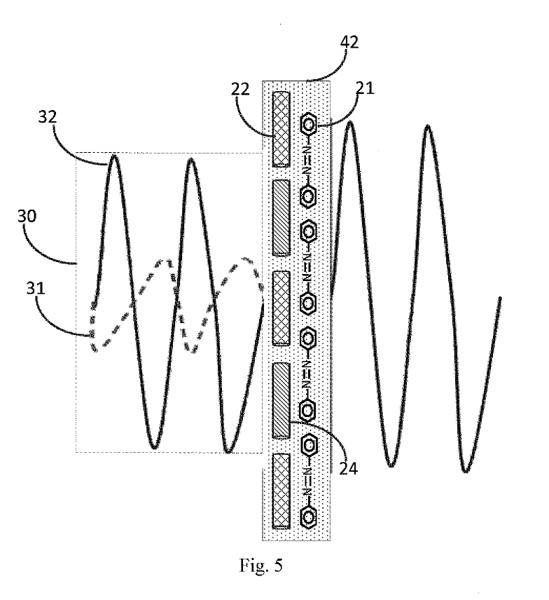

Please refer to FIG. 4. FIG. 4 is a schematic diagram of a backlight source shining on the polarizer according to a first embodiment of the present invention.

A method for fabricating the polarizer according to the first embodiment of the present invention is detailed as follows:

S101: Mixing a quantum rod with a solution of azo dyes according to a predetermined proportion for forming a mixed solution. The quantum rod comprises a red quantum rod 22, a blue quantum rod 23, and a green quantum rod 24.

S102: Soaking a polarizing layer which has undergone surface processing in the mixed solution for dyeing and stretching the polarizing layer with the wet-etching extension technique.

S103: Diverting a long axis of molecules of the azo dyes and a long axis of the quantum rod to a direction which a stretching force is applied to.

Both of molecules of the azo dyes and the quantum rods comprise a long axis, as FIG. 2 shows. Molecules of the azo dyes 21 and the quantum rods 22-24 are stretched with horizontal stretching force. Then, the long axis of molecules of the azo dyes 21 and the long axis of the quantum rods 22-24 are arranged horizontally.

S104: Absorbing a light beam perpendicular to a first direction with molecules of the azo dyes when a blue backlight source or a white backlight source shines so as to convert the backlight source as an non-polarized light into a polarized light. The first direction is parallel to the direction of the long axis of molecules of the azo dyes.

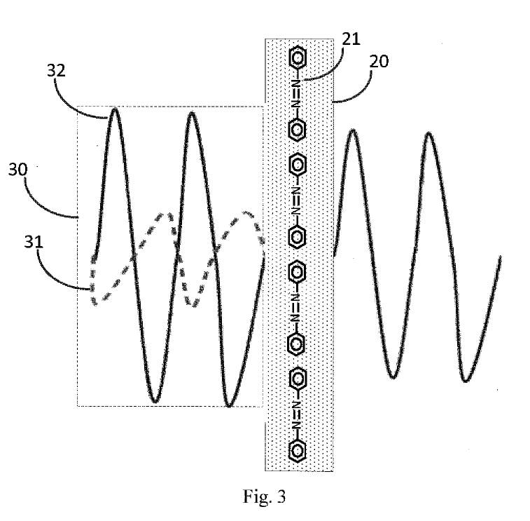

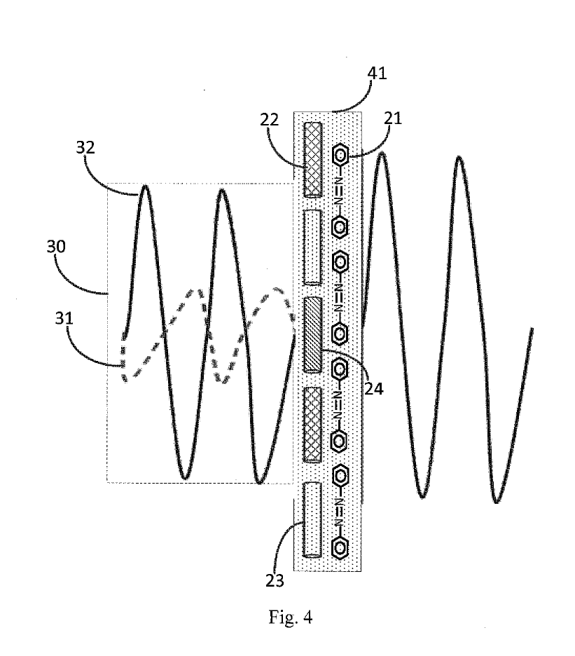

As FIG. 3 shows, a backlight source 30 comprises a light beam 31 perpendicular to the long axis of molecules of the azo dyes 21 and a light beam 32 parallel with the long axis of molecules of the azo dyes 21. FIG. 3 shows the light beam emitted by the light source shining on the polarizer 20 on the left side. FIG. 3 also shows the light beam dealt with by the polarizer 20 on the right side. The polarizer 20 only has azo dyes. Since the azo dyes have dichroism, the stretched azo-dye molecule 21 absorbs the light beam 31 perpendicular to the long axis of molecules of the azo dyes 21 while does not absorb the light beam 32 parallel with the long axis of molecules of the azo dyes 21.

S105: Converting a partial light beam perpendicular to the first direction into a light beam parallel with the first direction with the quantum rod so as to increase the transmittance of the polarizer. The first direction and the long axis of the quantum rod are in parallel.

As FIG. 4 shows, a polarizer 41 further comprises quantum rods 22-24. Based on Step S104, the partial light beam 31 perpendicular to the long axis of molecules of the azo dyes 21 is converted into a light beam parallel with the long axis of molecules of the azo dyes 21. The polarizer 41 deals with the light generated by the backlight source. The emitted light is as like what is shown on the right side of FIG. 4.

Contrast FIG. 3 with FIG. 4. The conventional polarizer 41 merely has azo dyes. The light beam along a perpendicular direction is absorbed. The strength of the light beam traversing the polarizing layer greatly decreases. The polarizing layer of the polarizer proposed by the present invention further comprises the quantum rods. The originally absorbed partial light beam can be converted into a light beam capable of traversing the polarizer. The strength of the light beam increases, and the transmittance of the LCD panel enhances as well.

Three kinds of colors are used for the quantum rods in the present invention so the backlight source can be blue or white. When the backlight source stimulates, it produces red, blue, and green lights. The red, blue, and green lights satisfy the need of the LCD panel showing colorful display. The use of the plurality of the spectral quantum rods further helps readjust the distribution of spectra of the backlight source, thereby improving chroma and color gamut of the LCD panel.

Please refer to FIG. 5. FIG. 5 is a schematic diagram of a backlight source shining on a polarizer according to a second embodiment of the present invention.

A method for fabricating the polarizer according to the second embodiment of the present invention is detailed as follows:

S201: Mixing a quantum rod with a solution of azo dyes according to a predetermined proportion for forming a mixed solution. The quantum rod comprises a red quantum rod 22 and a green quantum rod 24.

S202: Soaking a polarizing layer 42 which has undergone surface processing in the mixed solution for dyeing and stretching the polarizing layer 42 with the wet-etching extension technique.

S203: Diverting the long axis of the azo dyes and the long axis of the quantum rod to the direction where the stretching force is on after the stretching.

Both of molecules of the azo dyes and the quantum rods comprise a long axis, as FIG. 2 shows. Molecules of the azo dyes 21 and the quantum rods 22-24 are stretched with horizontal stretching force. Then, the long axis of molecules of the azo dyes 21 and the long axis of the quantum rods 22-24 are arranged horizontally.

S204: Absorbing the light beam perpendicular to a first direction with molecules of the azo dyes when a blue backlight source or a white backlight source shines so as to convert the backlight source as an non-polarized light into a polarized light. The first direction is parallel to the direction of the long axis of molecules of the azo dyes.

As FIG. 3 shows, a backlight source 30 comprises a light beam 31 perpendicular to the long axis of molecules of the azo dyes 21 and a light beam 32 parallel with the long axis of molecules of the azo dyes 21. FIG. 3 shows the light beam emitted by the light source shining on the polarizer 20 on the left side. FIG. 3 also shows the light beam dealt with by the polarizer 20 on the right side. The polarizer 20 only has azo dyes. Since the azo dyes have dichroism, the stretched azo-dye molecule 21 absorbs the light beam 31 perpendicular to the long axis of molecules of the azo dyes 21 while does not absorb the light beam 32 parallel with the long axis of molecules of the azo dyes 21.

S205: Converting a partial light beam perpendicular to the first direction into a light beam parallel with the first direction with the quantum rod so as to increase the transmittance of the polarizer. The first direction and the long axis of the quantum rod are in parallel.

As FIG. 5 shows, the polarizer 41 further comprises quantum rods 22 and 24. Based on Step S204, the partial light beam 31 perpendicular to the long axis of molecules of the azo dyes 21 is converted into a light beam parallel with the long axis of molecules of the azo dyes 21. The polarizer 41 deals with the light generated by the backlight source. The emitted light is as like what is shown on the right side of FIG. 5.

Contrast FIG. 3 with FIG. 5. The conventional polarizer merely has azo dyes. The light in a perpendicular direction is absorbed. The strength of the light traversing the polarizing layer greatly decreases. The polarizing layer of the polarizer proposed by the present invention further comprises the quantum rod. The originally absorbed partial light beam can be converted into a light beam capable of traversing the polarizer. The strength of the light beam increases, and the transmittance of the LCD panel enhances as well.

Two kinds of colors are used for the quantum rods in the present invention so the backlight source can be blue. After being excited by the blue backlight source, the red quantum rod and the green quantum rod emit a red light beam with polarization and a green light beam with polarization, respectively. The red light beam, the green light beam, and the blue backlight are mixed, and the mixed light beam is used as a light source for colorful display of the LCD panel. The use of the plurality of the quantum rods further helps readjust the distribution of spectra of the backlight source, thereby improving chroma and color gamut of the LCD panel.

Preferably, the mixed materials used in the polarizing layer comprises molecules of azo dyes capable of converting the backlight source as an non-polarized light into a polarized ligh.

Preferably, the polarizer is formed by dyeing and stretching the mixed materials of the polarizing layer. The quantum rods and the azo dyes in the present invention are stretched in the same process while the conventional quantum rods and the azo dyes are stretched in different processes. It shows that fewer processes are conducted in the present invention since the quantum rods and the azo dyes are stretched in the same process. Production costs are thus reduced owing to the reduction of processes.

Preferably, a backlight source cooperating with the polarizer is blue or white backlight source upon a condition that the red quantum rod, the green quantum rod, and the blue quantum rod are mixed as part of the raw materials for the polarizer.

Preferably, a backlight source cooperating with the polarizer is blue backlight source upon a condition that the red quantum rod and the green quantum rod are mixed as part of the raw materials for the polarizer.

The LCD panel and the polarizer and the method for fabricating the LCD panel and the polarizer are proposed by the present invention. The material for the polarizer is mixed with the quantum rods. Owing to anisotropy of the quantum rods, the transmittance of the polarizer increases, and chroma and color gamut of the LCD panel improve as well.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A method for fabricating a polarizer, comprising:
mixing a quantum rod with a solution of azo dyes according to a predetermined proportion for forming a mixed solution, the quantum rod comprising a red quantum rod and a green quantum rod;
soaking a polarizing layer which has undergone surface processing in the mixed solution for dyeing and stretching the polarizing layer with a wet-etching extension technique, and the quantum rod and the azo dyes being stretched in the same process;
diverting a long axis of molecules of the azo dyes and a long axis of the quantum rod to a direction which a stretching force is applied to;
the polarizer comprising the polarizing layer, and both of an azo-dye molecule and the quantum rod comprising the long axis.

2. The method of claim 1, wherein the quantum rod further comprises a blue quantum rod;
molecules of the azo dyes absorb light beam perpendicular to a first direction when a blue backlight source or a white backlight source shines so as to convert the backlight source as an non-polarized light into a polarized light, and the first direction is parallel to a direction of the long axis of molecules of the azo dyes;
the quantum rod converts a partial light beam perpendicular to the first direction into a light beam parallel with the first direction so as to increase transmittance of the polarizer, and the first direction and the long axis of the quantum rod are in parallel.

3. The method of claim 1, wherein molecules of the azo dyes absorbs the light beam perpendicular to a first direction when a blue backlight source shines so as to convert the backlight source as an non-polarized light into a polarized light, and the first direction is parallel to a direction of the long axis of molecules of the azo dyes;
the quantum rod converts a partial light beam perpendicular to the first direction into a light beam parallel with the first direction so as to increase transmittance of the polarizer, and the first direction and the long axis of the quantum rod are in parallel.

4. The method of claim 3, wherein the red quantum rod and the green quantum rod emit a red light beam with polarization and a green light beam with polarization, respectively, after being excited by the blue backlight source, and the red light beam, the green light beam, and the blue backlight are mixed as a light source for colorful display of a liquid crystal display (LCD) panel.

5. A liquid crystal display (LCD) panel comprising:
a first substrate;
a second substrate, arranged opposite to the first substrate;
a liquid crystal layer, placed between the first substrate and the second substrate; and
a polarizer, arranged on an outside area of the first substrate or an outside area of the second substrate, the polarizer comprising a polarizing layer, a quantum rod mixed in raw materials for the polarizing layer for forming mixed materials where the quantum rod is used for increasing transmittance of the polarizer.

6. The LCD panel of claim 5, wherein the mixed materials for the polarizing layer comprises azo dyes.

7. The LCD panel of claim 6, wherein the polarizer is fabricated after the mixed materials for the polarizing layer are dyed and stretched, and the quantum rod and the azo dyes are stretched in the same process.

8. The LCD panel of claim 5, wherein a backlight source cooperating with the polarizer is blue or white backlight source upon a condition that the red quantum rod, the green quantum rod, and the blue quantum rod are mixed as part of the raw materials for the polarizer.

9. The LCD panel of claim 5, wherein a backlight source cooperating with the polarizer is blue backlight source upon a condition that the red quantum rod and the green quantum rod are mixed as part of the raw materials for the polarizer.

10. A method for fabricating a polarizer, comprising:
mixing a quantum rod with a solution of azo dyes according to a predetermined proportion for forming a mixed solution;
soaking a polarizing layer which has undergone surface processing in the mixed solution for dyeing and stretching the polarizing layer with a wet-etching extension technique;
diverting a long axis of molecules of the azo dyes and a long axis of the quantum rod to a direction which a stretching force is applied to;
the polarizer comprising the polarizing layer, and both of an azo-dye molecule and the quantum rod comprising the long axis.

11. The method of claim 10, wherein the quantum rod comprises a red quantum rod, a green quantum rod, and a blue quantum rod;
molecules of the azo dyes absorb light beam perpendicular to a first direction when a blue backlight source or a white backlight source shines so as to convert the backlight source as an non-polarized light into a polarized light, and the first direction is parallel to a direction of the long axis of molecules of the azo dyes;
the quantum rod converts a partial light beam perpendicular to the first direction into a light beam parallel with the first direction so as to increase transmittance of the polarizer, and the first direction and the long axis of the quantum rod are in parallel.

12. The method of claim 10, wherein the quantum rod comprises a red quantum rod and a green quantum rod;
molecules of the azo dyes absorb light beam perpendicular to a first direction when a blue backlight source shines so as to convert the backlight source as an non-polarized light into a polarized light, and the first direction is parallel to a direction of the long axis of molecules of the azo dyes;
the quantum rod converts a partial light beam perpendicular to the first direction into a light beam parallel with the first direction so as to increase transmittance of the polarizer, and the first direction and the long axis of the quantum rod are in parallel.

13. The method of claim 12, wherein the red quantum rod and the green quantum rod emit a red light beam with polarization and a green light beam with polarization, respectively, after being excited by the blue backlight source, and the red light beam, the green light beam, and the blue backlight are mixed as a light source for colorful display of a liquid crystal display (LCD) panel.

14. The method of claim 10, wherein the quantum rod and the azo dyes are stretched in the same process.

15. The method of claim 10, wherein the first substrate is a color filter substrate and the second substrate is an array substrate.
